(19) United States
(12) Patent Application Publication
(10) Pub. No.: US 2019/0327345 A1
(43) Pub. Date: Oct. 24, 2019

(54) METHOD AND APPARATUS FOR FORWARDING HETEROGENEOUS PROTOCOL MESSAGE AND NETWORK SWITCHING DEVICE

(71) Applicants: Tianjin Chip Sea Innovation Technology Co. Ltd., Tianjin (CN); China National Digital Switching System Engineering & Tech R&D Center, Zhengzhou (CN)

(72) Inventors: Jiangxing Wu, Zhengzhou (CN); Qinrang Liu, Zhengzhou (CN); Yajing Huang, Zhengzhou (CN); Jianliang Shen, Zhengzhou (CN); Ping Lv, Zhengzhou (CN); Ting Chen, Zhengzhou (CN); Ke Song, Zhengzhou (CN); Xin Wang, Zhengzhou (CN); Zhenxi Yang, Zhengzhou (CN); Peijie Li, Zhengzhou (CN); Dongpei Liu, Zhengzhou (CN); Ke Zhu, Tianjin (CN)

(73) Assignees: Tianjin Chip Sea Innovation Technology Co. Ltd., Tianjin (CN); China National Digital Switching System Engineering & Tech R&D Center, Zhengzhou (CN)

(21) Appl. No.: 16/376,710

(22) Filed: Apr. 5, 2019

(30) Foreign Application Priority Data
Apr. 23, 2018 (CN) 201810369923.2

(51) Int. Cl. H04L 29/06; H04L 12/24; H04L 12/741; H04L 12/721

(52) U.S. Cl. CPC H04L 69/08; H04L 45/66; H04L 45/74; H04L 41/0806

(57) ABSTRACT

A method and an apparatus for forwarding a heterogeneous protocol message, and a network switching device are provided, the method includes: receiving a network message; parsing the network message to obtain a destination address of the network message; looking up in a preset forwarding table a port corresponding to the destination address and a first protocol corresponding to the port; judging whether the first protocol matches a second protocol of the network message; performing, if not, protocol conversion on the network message in accordance with a preset conversion rule, so that the protocol type of the network message matches the port; forwarding the protocol-converted network message through the port. In the present disclosure, protocol conversion can be performed on messages from different protocol networks, so that the network switching device implements communication between different networks, and has a flexible protocol processing mode and powerful scalability.

### CROSS-REFERENCE TO RELATED APPLICATIONS

The present application claims priority to Chinese Patent Disclosure No. 201810369923.2, filed with the China National Intellectual Property Administration on Apr. 23, 2018, entitled “Method and Apparatus for Forwarding Heterogeneous Protocol Message and Network Switching Device”, which is herein incorporated by reference in its entirety.

### TECHNICAL FIELD

The present disclosure relates to the technical field of communication protocols, and in particular to a method and an apparatus for forwarding a heterogeneous protocol message, and a network switching device.

### BACKGROUND

In a communication network, information devices mostly communicate based on the same protocol, and a switching device supporting the corresponding communication protocol is required between the devices to implement interconnections. It is required that the network switching device is able to parse a protocol message, look up a forwarding table, and forward the protocol message to a corresponding destination port. The existing network switching devices support a fixed protocol and usually are only able to process a single type of protocol message. Since there are great differences between different network protocol standards, for example, in packet format, packet length, the number of address bits, etc., protocol conversion is generally performed by a gateway or a bridge device in order to implement communications between network devices based on different protocols, resulting in limitation on network organization and poor scalability of the heterogeneous protocol networks.

### SUMMARY

In view of the above, objects of the present disclosure include providing a method and an apparatus for forwarding a heterogeneous protocol message, and a network switching device, so that the network switching device implements communications between networks with different protocols, and has a flexible protocol processing mode with a powerful scalability.

The present disclosure provides a method for forwarding a heterogeneous protocol message, wherein the method is applicable to a network switching device, and the method comprises: receiving a network message; parsing the network message to obtain a destination address of the network message; looking up in a preset forwarding table a port corresponding to the destination address and a first protocol corresponding to the port; judging whether the first protocol matches a second protocol of the network message; performing, if not, protocol conversion on the network message in accordance with a preset conversion rule, so that the protocol type of the network message matches the port; forwarding the protocol-converted network message through the port.

The present disclosure further provides an apparatus for forwarding a heterogeneous protocol message, wherein the apparatus is arranged in a network switching device, and the apparatus comprises: a receiving module configured to receive a network message; a parsing module configured to parse the network message to obtain a destination address of the network message; a lookup module configured to look up in a preset forwarding table a port corresponding to the destination address and a first protocol corresponding to the port; a judging module configured to judge whether the first protocol matches a second protocol of the network message; a protocol conversion module configured to perform, if the first protocol does not match the second protocol of the network message, protocol conversion on the network message in accordance with a preset conversion rule, so that the protocol type of the network message matches the port; and a forwarding module configured to forward the protocol-converted network message through the port.

An embodiment of the present disclosure further provides a network switching device comprising a memory and a processor, wherein the memory is configured to store one or more computer instructions, which are executed by the processor to implement the abovementioned method for forwarding a heterogeneous protocol message.

Other features and advantages of the present disclosure will be set forth in the description which follows, or in part may be inferred or undoubtedly determined from the description, or may be learned by practice of the above techniques of the present disclosure.

In order to make the above objects, features and advantages of the present disclosure more apparent and understandable, preferred embodiments will be described in detail below by way of example with reference to the accompanying drawings.

### BRIEF DESCRIPTION OF THE DRAWINGS

For illustrating technical solutions of specific embodiments of the present disclosure or of the prior art more clearly, drawings required for use in the description of the specific embodiments or the prior art will be introduced briefly below. It is obvious that the drawings in the following description are merely illustrative of some embodiments of the present disclosure. It would be understood by those of ordinary skill in the art that other drawings could also be obtained from these drawings without any inventive effort.

FIG. 1 is a flowchart of a method for forwarding a heterogeneous protocol message provided in an embodiment of the present disclosure;

FIG. 2 is a flowchart of another method for forwarding a heterogeneous protocol message provided in an embodiment of the present disclosure;

FIG. 3 is a flowchart of a yet another method for forwarding a heterogeneous protocol message provided in an embodiment of the present disclosure;

FIG. 4 is a structural diagram of a physical circuit for implementing a method for forwarding a heterogeneous protocol message provided in an embodiment of the present disclosure;

FIG. 5 is a schematic structural diagram of an apparatus for forwarding a heterogeneous protocol message provided in an embodiment of the present disclosure;

FIG. 6 is a schematic structural diagram of a network switching device provided in an embodiment of the present disclosure.

### DETAILED DISCLOSURE

In order to make the objects, technical solutions and advantages of the embodiments of the present disclosure more clear, the technical solutions of the present disclosure will be described below clearly and completely with reference to the accompanying drawings. It is apparent that the embodiments to be described are some, but not all of the embodiments of the present disclosure. All the other embodiments obtained by those of ordinary skill in the art in light of the embodiments of the present disclosure without inventive efforts would fall within the scope of the present disclosure as claimed.

The existing network switching devices support a single communication protocol, and are only able to parse a specific protocol packet header, and determine a parsing depth according to requirements of the switching function; a process of processing a message by the network switching device is relatively fixed, and communications between networks with different protocols cannot be performed. Taking the Ethernet as an example, the existing network devices parse a data packet layer by layer in accordance with a fixed processing flow according to the function of a switch or a router following a MAC controller (the MAC controller is a chip of the data link layer in the Ethernet), but for other communication protocols, such as RapidIO, Infiniband, Fibre Channel, or the like, message processing cannot be normally performed.

The abovementioned RapidIO is mainly applied to internal interconnections of embedded systems, to support chip-to-chip and board-to-board communications, and may be used as a backplane connection of embedded devices; and the abovementioned InfiniBand is mainly used for connections at a server end, for example communications between servers and servers (such as replication, distributed work, etc.), between servers and storage devices (such as SAN and direct storage accessories), and between servers and networks (such as LAN, WANs, and the Internet).

Considering that the existing network switching devices are only able to process messages of the same protocol and has the problem of poor protocol compatibility and scalability, an embodiment of the present disclosure provides a method and an apparatus for forwarding a heterogeneous protocol message, and a network switching device; wherein the technical method may be applicable to various network switching devices; in the present embodiment, a protocol may also be referred to as a Layer 2 protocol, that is, a data link layer protocol; the technology may be implemented with related software or hardware, and will be described below by way of example.

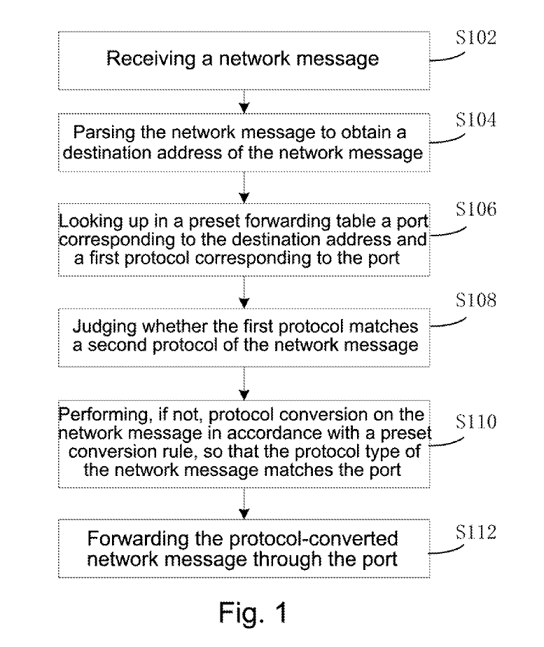

Referring to a flowchart of a method for forwarding a heterogeneous protocol message shown in FIG. 1, the method is applicable to a network switching device, and the method comprises the following steps:

step S102 of receiving a network message;

wherein the network message is a basic data unit for exchange and transmission that is received by the network switching device, that is, the network message is a data block to be sent by a site at one time; the message contains complete data information to be sent, which is unlimited and variable in length;

step S104 of parsing the network message to obtain a destination address of the network message;

wherein the network switching device parses the network message received from a network, it can obtain various information from the message, and can extract other useful protocol fields, such as a source address, a priority and so on carried in the network message, in addition to the abovementioned destination address;

step S106 of looking up in a preset forwarding table a port corresponding to the destination address and a first protocol corresponding to the port;

wherein, specifically, when the network switching device is being initialized, the abovementioned forwarding table may be pre-configured (the forwarding table may also be referred to as a mapping table), and the forwarding table may contain table entries such as a port number of a port, a first protocol of a network to which the port is connected, and a destination address corresponding to the port; the forwarding table may be stored in a distributed manner in a RAM (Random Access Memory) of each port or stored in a centralized manner in a RAM of the network switching device; and the forwarding table may be a unicast table, or may also be a multicast table;

step S108 of judging whether the first protocol matches a second protocol of the network message;

wherein in actual implementation, it may be judged whether the first protocol is the same as the second protocol of the network message, or it may also be judged whether the second protocol of the network message is compatible with the first protocol;

step S110 of performing, if not, protocol conversion on the network message in accordance with a preset conversion rule, so that the protocol type of the network message matches the port;

wherein different protocols may be different in packet format, packet length, number of address bits, etc.; a corresponding relation between each two protocols is contained in the abovementioned preset conversion rule; for example, the message may be converted from the second protocol to the first protocol by multiple methods such as replacing a field, deleting a field, and adding a field, and the data in the message is encapsulated by using the first protocol after the conversion is completed;

step S112 of forwarding the protocol-converted network message through the port; wherein the network message may be forwarded to a core network, or may also be forwarded into other network devices of an access network.

The embodiment of the present disclosure provides a method for forwarding a heterogeneous protocol message, in which a network switching device parses the received network message to obtain a destination address of the network message; a port corresponding to the destination address and a first protocol corresponding to the port are looked up in a preset forwarding table; if the first protocol does not match a second protocol of the network message, protocol conversion is performed on the network message in accordance with a preset conversion rule; and after the protocol type of the network message matches the port, the protocol-converted network message is forwarded through the port. In this way, protocol conversion can be performed on messages from different protocol networks, so that the network switching device implements communications between networks with different protocols, and has a flexible protocol processing mode with a powerful scalability.

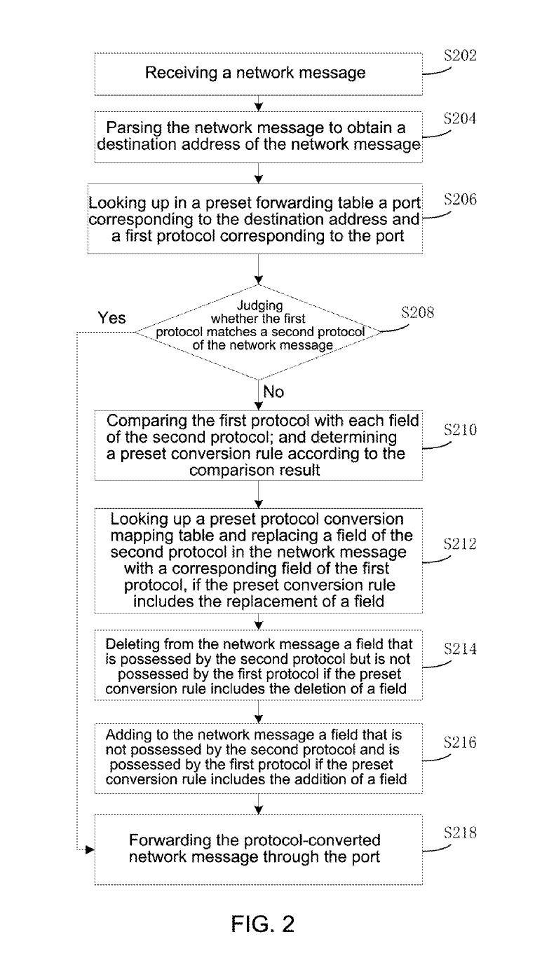

Referring to a flowchart of another method for forwarding a heterogeneous protocol message shown in FIG. 2, the method is implemented on the basis of the method shown in FIG. 1, and the method is applicable to a network switching device; and the method comprises the following steps:

Step S202 of receiving a network message;

Step S204 of parsing the network message to obtain a destination address of the network message;

wherein a related field containing information such as a destination address may be extracted by parsing a protocol packet header of the network message; depending on the type and setting of the current Layer 2 protocols, different fields need to be extracted, while including at least a destination address for forwarding, in order to look up a forwarding table;

Step S206 of looking up in a preset forwarding table a port corresponding to the destination address and a first protocol corresponding to the port;

Step S208 of judging whether the first protocol matches a second protocol of the network message; executing step S218 if yes; or executing step S210 if not;

Step S210 of comparing the first protocol with each field of the second protocol; and determining a preset conversion rule according to the comparison result; wherein the preset conversion rule may include one or more of replacement of a field, deletion of a field, and addition of a field;

Step S212 of looking up a preset protocol conversion mapping table and replacing a field of the second protocol in the network message with a corresponding field of the first protocol, if the preset conversion rule includes the replacement of a field;

In the protocol conversion mapping table, respective fields of the first protocol and the second protocol are compared and mapped, and a preset conversion rule is determined according to the comparison result. For example, if the comparison result indicates that the second protocol includes a field that is not possessed by the first protocol, it is determined that the preset conversion rule includes deletion of a field. If the comparison result indicates that the second protocol does not possess a field included in the first protocol, it is determined that the preset conversion rule includes addition of a field. If the comparison result indicates that there is a field in the second protocol that is inconsistent with that in the first protocol, it is determined that the preset conversion rule includes replacement of a field. Here, the deletion of a field, the addition of a field, and the replacement of a field in the conversion rule may coexist, and the second protocol may be converted to the first protocol by, for example, in the network message, deleting certain fields in the second protocol from the network message, adding certain fields in the second protocol, and replacing certain fields in the second protocol.

The abovementioned step of looking up a preset protocol conversion mapping table and replacing a field of the second protocol in the network message with a corresponding field of the first protocol may be specifically implemented in the following way: looking up a source address mapping subtable, a destination address mapping subtable, and a priority mapping subtable in the protocol conversion mapping table, and replacing fields of the second protocol in the network message with corresponding fields of the first protocol; and the source address mapping subtable, the destination address mapping subtable, and the priority mapping subtable may be used for conversion of fields saved as a source address, a destination address, and a priority, respectively. For example, field locations for saving source addresses in various protocols, and a manner of mapping source address fields between various protocols are saved in respective table entries of the abovementioned source address mapping subtable. For example, a field location for saving a destination address may be set at field A in the first protocol and may be set at field B in the second protocol; and the destination address may be transferred from the field B to the field A during protocol conversion.

Specifically, the abovementioned step may be implemented by the following process: looking up respectively the mapping relations between the first protocol and the second protocol in terms of field locations where a source address is stored, a field location where a destination address is stored, and a field location where a priority is stored, with the mapping relations in the source address mapping subtable, the destination address mapping subtable and the priority mapping subtable in the protocol conversion mapping table, so as to obtain field locations in the first protocol which are corresponding to the field locations of the source address, the destination address, and the priority of the second protocol; replacing the fields of the second protocol with the corresponding fields of the first protocol according to the found field locations.

Step S214 of deleting from the network message a field that is possessed by the second protocol but is not possessed by the first protocol if the preset conversion rule includes the deletion of a field;

Step S216 of adding to the network message a field that is not possessed by the second protocol and is possessed by the first protocol if the preset conversion rule includes the addition of a field;

In actual implementation, a field that is not possessed by the second protocol and is possessed by the first protocol, and a field that is not possessed by the first protocol and is possessed by the second protocol may be saved in the abovementioned protocol conversion mapping table or other mapping tables, for addition or deletion of the field during mutual conversions between the first protocol and the second protocol.

Specifically, the abovementioned preset conversion rule may also be described as follows: the replacement of a field is achieved by looking up the protocol conversion mapping table and replacing a field in the original Layer 2 protocol packet with a field in a new Layer 2 protocol packet; the deletion of a field means that the new Layer 2 protocol packet does not have a field corresponding to a certain field in the original Layer 2 protocol packet, and the field can be directly deleted when the new Layer 2 protocol packet is being encapsulated; and the addition of a field means that it is necessary to add a field during encapsulation of a protocol packet of a new Layer 2 protocol according to a preset protocol conversion rule, and the original Layer 2 protocol packet does not have a field corresponding to the field to be added.

Step S218 of forwarding the protocol-converted network message through the port.

In actual implementation, the abovementioned method for forwarding a heterogeneous protocol message may be implemented by the following physical circuits: a heterogeneous Layer 2 protocol parser module defined by a software, configured to parse a heterogeneous Layer 2 protocol and extract a field of the protocol; a fusion routing table lookup module configured to look up a corresponding port number, a protocol conversion type, and so on in regard to a destination address of the heterogeneous protocol extracted by the parser; a protocol conversion table lookup module configured to look up a protocol conversion mapping table in regard to a field required to be replaced during protocol conversion, to acquire a converted new protocol field; and a protocol conversion module configured to perform an operation such as deletion of a field, replacement of a field, or addition of a field on a Layer 2 protocol message which requires protocol conversion, and re-encapsulating the same into a new Layer 2 protocol message to implement the function of converting the Layer 2 protocol.

As can be seen from the above, in the embodiment of the present disclosure, firstly the parsing of a heterogeneous Layer 2 protocol is implemented by using a heterogeneous Layer 2 protocol parser module defined by a software; then a forwarding table is looked up in regard to a destination address of the heterogeneous Layer 2 protocol by the fusion routing table lookup module to acquire a forwarding port number and a conversion type, and it is judged, according to a table lookup result, whether a protocol conversion is required; subsequently a protocol conversion table is looked up in the protocol conversion table lookup module to acquire a field to be replaced of a new Layer 2 protocol; and finally, the encapsulation of a protocol packet of the new Layer 2 protocol is carried out in the protocol conversion module. The entire process achieves the parsing and table lookup and protocol conversion of the heterogeneous Layer 2 protocol by the network switching device, and achieves communications between networks based on different Layer 2 protocols. Compared with the prior art, the protocol processing method provided in the embodiment of the present disclosure is more flexible, has a powerful scalability, and can be used for communications between heterogeneous Layer 2 protocols.

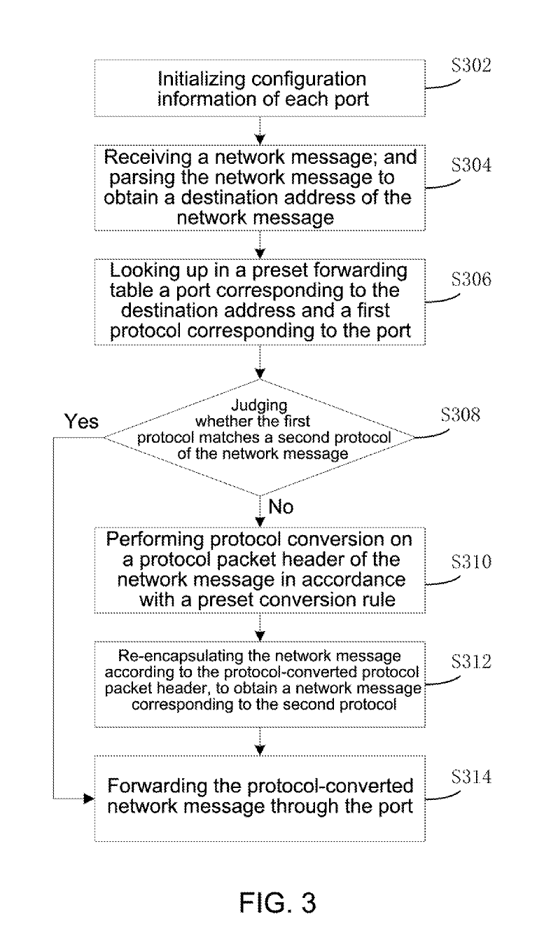

Referring to a flowchart of a yet another method for forwarding a heterogeneous protocol message shown in FIG. 3, the method is implemented on the basis of the abovementioned method shown in FIG. 1 or FIG. 2; the method is applied to a network switching device, and the method comprises:

step S302 of initializing configuration information of each port, wherein the configuration information includes at least a protocol type, a forwarding table, and a conversion rule;

wherein the abovementioned process of initializing the device and the port may also include configuring a Layer 2 protocol type, a heterogeneous protocol parsing rule, an address matching rule, a forwarding table, a protocol conversion rule, and so on for each port; in the present embodiment, when the configuration information of each port is being initialized, a protocol type and a protocol conversion mode for port may be configured for each port, and a protocol parsing rule is set according to the protocol type and the protocol conversion mode, wherein the protocol parsing rule includes a parsing field of a network message to be parsed; that is, a field to be parsed of the protocol packet may be set according to the Layer 2 protocol type of the current port and the protocol conversion mode; optionally, a mapping table for the port which table contains a mapping relation between a destination address corresponding to the port and a port number of the port as well as the protocol type of the port may be configured; in addition, a protocol conversion rule for the port may also be configured, with the protocol conversion rule including a manner of mapping corresponding fields in different types of protocols;

step S304 of receiving a network message; and parsing the network message to obtain a destination address of the network message;

step S306 of looking up in a preset forwarding table a port corresponding to the destination address and a first protocol corresponding to the port;

step S308 of judging whether the first protocol matches a second protocol of the network message; executing step S314 if yes; or executing step S310 if not;

step S310 of performing protocol conversion on a protocol packet header of the network message in accordance with a preset conversion rule;

wherein the protocol conversion mode includes actions such as replacement of a protocol field, deletion of a field, addition of a field, etc.; and a corresponding field in the current protocol packet header is replaced with a protocol-converted field to form a protocol-converted protocol packet header, which is re-encapsulated into a converted Layer 2 protocol message;

step S312 of re-encapsulating the network message according to the protocol-converted protocol packet header, to obtain a network message corresponding to the second protocol;

step S314 of forwarding the protocol-converted network message through the port. For example, the network message may be sent to a core switching module in the device for processing.

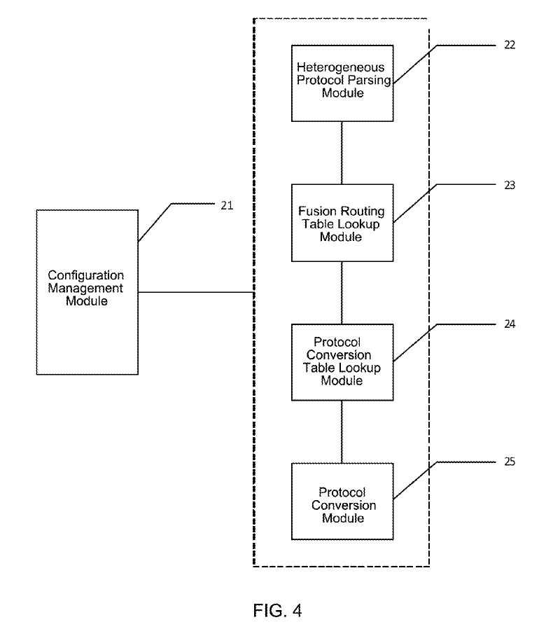

In actual implementation, the abovementioned method for forwarding a heterogeneous protocol message may be implemented by the following physical circuit. As shown in FIG. 4, the physical circuit comprises a configuration management module 21 for performing initialization configuration of each module of a system, and tracking the status of and managing the configuration of each module when the system is running;

a heterogeneous protocol parsing module 22 is configured to parse a protocol packet received by the device, and transfer the parsed field of the protocol header to a fusion routing table lookup module 23 and a protocol conversion table lookup module 24 and a protocol conversion module 25 according to the configuration case;

the fusion routing table lookup module 23 is configured to look up a corresponding forwarding port number according to the destination address parsed by the heterogeneous protocol parsing module 22, where a forwarding table is configured by the configuration management module when the device is being initialized, and may be a mapping table of any Layer 2 protocol address and forwarding port;

the protocol conversion table lookup module 24 is configured to perform a table lookup operation on a field to be replaced in a data packet which requires conversion of a Layer 2 protocol, to obtain a corresponding field of the converted protocol, where a protocol conversion table is configured by the configuration management module when the device is being initialized, and contains at least an address conversion table and other field conversion tables required for mapping in the conversion of the Layer 2 protocol;

the protocol conversion module 25 is configured to replace, for the data packet which requires conversion of the Layer 2 protocol, a packet header field in the original Layer 2 protocol packet with a packet header field of a new Layer 2 protocol according to the table lookup result in the protocol conversion table lookup module 24, and re-encapsulating a new Layer 2 protocol data packet.

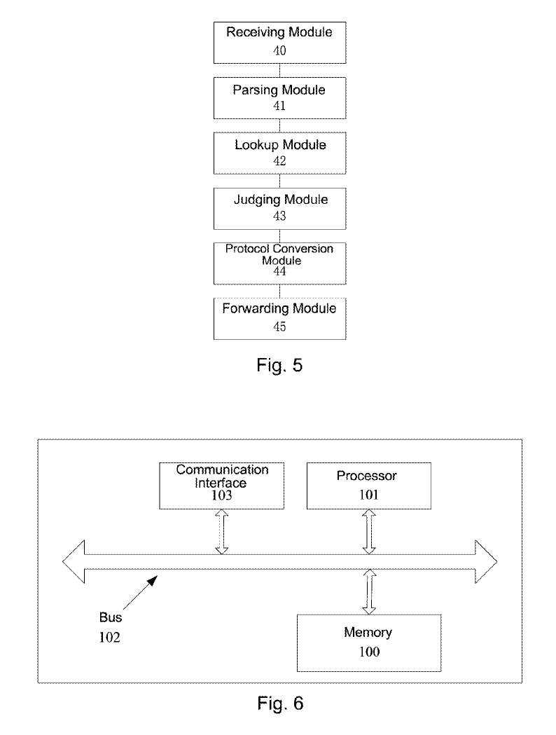

An embodiment of the present disclosure provides an apparatus for forwarding a heterogeneous protocol message, corresponding to the foregoing method embodiment. As shown in FIG. 5, the apparatus comprises:

a receiving module 50 configured to receive a network message;

a parsing module 51 configured to parse the network message to obtain a destination address of the network message;

a lookup module 52 configured to look up in a preset forwarding table a port corresponding to the destination address and a first protocol corresponding to the port;

a judging module 53 configured to judge whether the first protocol matches a second protocol of the network message;

a protocol conversion module 54 configured to perform, if the first protocol does not match the second protocol of the network message, protocol conversion on the network message in accordance with a preset conversion rule, so that the protocol type of the network message matches the port; and

a forwarding module 55 configured to forward the protocol-converted network message through the port.

The abovementioned apparatus further comprises: an initialization module configured to initialize configuration information of each port, wherein the configuration information includes at least a protocol type, a forwarding table, and a conversion rule.

The embodiment of the present disclosure provides an apparatus for forwarding a heterogeneous protocol message, which can look up a protocol conversion table, and replace a field, delete a field, or add a field for a network message which requires protocol conversion to make a first protocol of the network message match a second protocol, so that a network switching device is capable of processing messages of multiple protocols, and the protocol compatibility and scalability of the network switching device are improved.

The abovementioned method and apparatus for forwarding a heterogeneous protocol message provide a method used for the parsing, fusion matching table lookup, and protocol conversion of a heterogeneous Layer 2 protocol in a network switching device which is implemented based on hardware, to solve the problem in processing a heterogeneous Layer 2 protocol message by the network switching device, thereby further implementing communications between networks of heterogeneous Layer 2 protocols. In this way, protocol conversion can be performed on messages from different protocol networks, so that the network switching device implements communications between networks with different protocols, and has a flexible protocol processing mode with a powerful scalability.

The present embodiment provides a network switching device corresponding to the foregoing method embodiment. FIG. 6 is a schematic structural diagram of the network switching device. As shown in FIG. 6, the network switching device comprises a memory 100 and a processor 101; wherein the memory 100 is configured to store one or more computer instructions, which are executed by the processor to implement the abovementioned method for forwarding a heterogeneous protocol message, where the method may include one or more of the above methods.

Further, a cloud server shown in FIG. 6 further comprises a bus 102 and a communication interface 103, and the processor 101, the communication interface 103, and the memory 100 are connected by the bus 102.

Here, the memory 100 may include a high-speed random access memory (RAM), or may also include a non-volatile memory, for example, at least one disk memory. The communication connection between a network element of the system and at least one other network element is implemented by at least one communication interface 103 (which may be wired or wireless), and the Internet, a wide area network, a local area network, a metropolitan area network, or the like may be used. The bus 102 may be an ISA bus, a PCI bus, an EISA bus, or the like. The bus may be divided into an address bus, a data bus, a control bus, and the like. For ease of representation, the bus is represented with only one double-headed arrow in FIG. 6, but it does not mean that there is only one bus or one type of bus.

The processor 101 may be an integrated circuit chip with a signal processing capability. In the implementation process, each of the steps of the abovementioned method may be carried out by an integrated logic circuit of hardware in the processor 101 or an instruction in a form of software. The abovementioned processor 101 may be a general-purpose processor, including a central processing unit (simply referred to as CPU), a network processor (simply referred to as NP), etc., or may also be a digital signal processor (simply referred to as DSP), an disclosure specific integrated circuit (simply referred to as ASIC), a field-programmable gate array (simply referred to as FPGA) or other programmable logic device, discrete gate or transistor logic device, or discrete hardware component. The methods, steps, and logical block diagrams disclosed in the embodiments of the present disclosure may be implemented or executed. The general-purpose processor may be a microprocessor, or the processor may also be any conventional processor or the like. The steps in connection with the method disclosed in the embodiment of the present disclosure may be directly embodied to be carried out by a hardware decoding processor, or be carried out with a combination of software modules and hardware in the decoding processor. The software module may be located in a storage medium developed in the art such as a random access memory, a flash memory, a read only memory, a programmable read only memory or an electrically erasable programmable memory, a register, or the like. The storage medium is located in the memory 100, and the processor 101 reads information in the memory 100 and carries out the steps of the method of the foregoing embodiment in combination with its hardware.

An embodiment of the present disclosure further provides a machine-readable storage medium storing a machine executable instruction that, when called and executed by a processor, causes the processor to implement the abovementioned method for forwarding a heterogeneous protocol message. Reference may be made to the method embodiment for the specific implementation, which is not described repeatedly herein.

Certain embodiments of the present disclosure can bring about beneficial effects, for example:

In a method and an apparatus for forwarding a heterogeneous protocol message and a network switching device provided in the embodiments of the present disclosure, the network switching device parses the received network message to obtain a destination address of the network message; a port corresponding to the destination address and a first protocol corresponding to the port are looked up in a preset forwarding table; if the first protocol does not match a second protocol of the network message, a protocol conversion is performed on the network message in accordance with a preset conversion rule; and after the protocol type of the network message matches the port, the protocol-converted network message is forwarded through the port. In this way, protocol conversion can be performed on messages from different protocol networks, so that the network switching device implements communications between networks with different protocols, and has a flexible protocol processing mode with a powerful scalability.

If implemented in the form of a software functional module and sold or used as an independent product, the functions may be stored in a computer-readable storage medium. Based on such understanding, the technical solution of the present disclosure essentially, or the part thereof contributing to the prior art, or a part of the technical solution may be embodied in the form of a software product. The computer software product is stored in a storage medium, and includes a number of instructions for causing a computer device (which may be a personal computer, a server, a network device or the like) to execute all or some of the steps of the methods described in the various embodiments of the present disclosure. The foregoing storage medium includes any medium that can store program codes, such as a USB flash disk, a mobile hard disk, a read-only memory (ROM), a random access memory (RAM), a magnetic disk, an optical disk or the like.

Finally, it should be noted that the embodiments described above are merely specific embodiments of the present disclosure for illustrating the technical solutions of the present disclosure, but not intended to limit the disclosure, and the scope of protection of the present disclosure is not limited thereto. Although the present disclosure has been described in detail with reference to the foregoing embodiments, it should be understood by those of ordinary skill in the art that, any person skilled in the art may modify the technical solutions disclosed in the foregoing embodiments or easily conceive of variations thereof or substitute part of the technical features with equivalents within the scope of the technique disclosed in the present disclosure; and all these modifications, variations or substitutions will not cause the gist of the corresponding technical solutions to depart from the spirit and scope of the technical solutions of the embodiments of the present disclosure and should be encompassed in the scope of protection of the present disclosure. Therefore, the scope of protection of the present disclosure should be determined based on the scope of the claims.

### INDUSTRIAL APPLICABILITY

In the solution for forwarding a heterogeneous protocol message, protocol conversion can be performed on messages from different protocol networks, so that the network switching device implements communications between networks with different protocols, and has a flexible protocol processing mode with a powerful scalability.

1. A method for forwarding a heterogeneous protocol message, wherein the method is applicable to a network switching device, and the method comprises steps of:
receiving a network message;
parsing the network message to obtain a destination address of the network message;
looking up in a preset forwarding table a port corresponding to the destination address and a first protocol corresponding to the port;
judging whether the first protocol matches a second protocol of the network message;
performing, if not, protocol conversion on the network message in accordance with a preset conversion rule, so that the protocol type of the network message matches the port; and
forwarding the protocol-converted network message through the port.

2. The method according to claim 1, wherein the preset conversion rule includes at least one of replacement of a field, deletion of a field, and addition of a field.

3. The method according to claim 2, wherein if the preset conversion rule includes the replacement of a field, the step of performing protocol conversion on the network message comprises: looking up a preset protocol conversion mapping table, and replacing a field of the second protocol in the network message with a corresponding field of the first protocol;
if the preset conversion rule includes the deletion of a field, the step of performing protocol conversion on the network message includes: deleting from the network message a field that is possessed by the second protocol but is not possessed by the first protocol; and
if the preset conversion rule includes the addition of a field, the step of performing protocol conversion on the network message includes: adding to the network message a field that is not possessed by the second protocol and is possessed by the first protocol.

4. The method according to claim 3, wherein if the preset conversion rule includes the replacement of a field, the step of looking up a preset protocol conversion mapping table and replacing a field of the second protocol in the network message with a corresponding field of the first protocol comprises:
looking up a source address mapping subtable, a destination address mapping subtable, and a priority mapping subtable in the protocol conversion mapping table, and replacing fields of the second protocol in the network message with corresponding fields of the first protocol.

5. The method according to claim 4, wherein the step of looking up a source address mapping subtable, a destination address mapping subtable, and a priority mapping subtable in the protocol conversion mapping table, and replacing fields of the second protocol in the network message with corresponding fields of the first protocol comprises:
looking up respectively the mapping relations between the first protocol and the second protocol in terms of field locations where a source address is stored, a field location where a destination address is stored, and a field location where a priority is stored, with the mapping relations in the source address mapping subtable, the destination address mapping subtable and the priority mapping subtable in the protocol conversion mapping table, so as to obtain field locations in the first protocol which are corresponding to the field locations of the source address, the destination address, and the priority of the second protocol; and
replacing the fields of the second protocol with the corresponding fields of the first protocol, according to the found field locations.

6. The method according to claim 1, wherein after judging that the first protocol does not match the second protocol of the network message, the method further comprises:
comparing the first protocol with each field of the second protocol; and
determining the preset conversion rule according to the comparison result.

7. The method according to claim 6, wherein the step of determining the preset conversion rule according to the comparison result comprises:
determining that the preset conversion rule includes deletion of a field, if the comparison result indicates that the second protocol includes a field that is not possessed by the first protocol;
determining that the preset conversion rule includes addition of a field, if the comparison result indicates that the second protocol does not possess a field included in the first protocol; and
determining that the preset conversion rule includes replacement of a field, if the comparison result indicates that there is a field in the second protocol that is inconsistent with that in the first protocol.

8. The method according to claim 1, wherein the step of performing protocol conversion on the network message comprises:
performing protocol conversion on a protocol packet header of the network message; and
re-encapsulating the network message according to the protocol-converted protocol packet header, to obtain a network message corresponding to the second protocol.

9. The method according to claim 1, wherein the method further comprises: initializing configuration information of each port, and the configuration information includes at least a protocol type, a forwarding table, and a conversion rule.

10. The method according to claim 9, wherein the step of initializing configuration information of each port includes:
configuring, for each port, the protocol type and the protocol conversion mode of each of the ports, and setting a protocol parsing rule according to the protocol type and the protocol conversion mode, and the protocol parsing rule includes a parsing field of a network message to be parsed;
configuring a mapping table of each of the ports, with the mapping table containing a mapping relation between a destination address corresponding to the port and a port sequential number of the port as well as the protocol type of the port; and
configuring a protocol conversion rule of the port, with the protocol conversion rule including a manner of mapping corresponding fields in different types of protocols.

11. An apparatus for forwarding a heterogeneous protocol message, wherein the apparatus is provided in a network switching device and the apparatus comprises:
a receiving module configured to receive a network message;
a parsing module configured to parse the network message to obtain a destination address of the network message;
a lookup module configured to look up in a preset forwarding table a port corresponding to the destination address and a first protocol corresponding to the port;
a judging module configured to judge whether the first protocol matches a second protocol of the network message;
a protocol conversion module configured to perform, if the first protocol does not match the second protocol of the network message, protocol conversion on the network message in accordance with a preset conversion rule, so that the protocol type of the network message matches the port; and
a forwarding module configured to forward the protocol-converted network message through the port.

12. The apparatus according to claim 11, wherein the apparatus further comprises: an initialization module configured to initialize configuration information of each port, and the configuration information includes at least a protocol type, a forwarding table, and a conversion rule.

13. A network switching device, comprising a memory and a processor, wherein the memory is configured to store one or more computer instructions, which are executed by the processor to implement the method of claim 1.
